(19) United States
(12) Patent Application Publication
(10) Pub. No.: US 2025/0078476 A1
(43) Pub. Date: Mar. 6, 2025

(54) INFORMATION PROCESSING DEVICE AND METHOD

(71) Applicant: TOYOTA JIDOSHA KABUSHIKI KAISHA, Toyota-shi (JP)

(72) Inventor: Kouji NAGOU, Kyoto-shi (JP)

(73) Assignee: TOYOTA JIDOSHA KABUSHIKI KAISHA, Toyota-shi (JP)

(21) Appl. No.: 18/777,024

(22) Filed: Jul. 18, 2024

(30) Foreign Application Priority Data
Aug. 30, 2023 (JP) 2023-139694

(51) Int. Cl. G06V 10/774; G06T 7/73; G06V 10/147; G06V 10/44; G06V 10/74

(52) U.S. Cl. CPC G06V 10/774; G06T 7/73; G06V 10/147; G06V 10/44; G06V 10/761; G06T 2207/20081

(57) ABSTRACT

The terminal receives a local image feature amount of one or more first objects included in a first image from a server, acquires a local image feature amount of one or more objects included in a captured image for each of a plurality of images captured by the camera based on the result of detection of objects by the first sensor, and transmits a second captured image to the server as one of learning data for a machine learning model for use in image recognition. The server transmits the local image feature amount of the one or more first objects to the terminal, receives the second captured image from the terminal, and stores the second captured image as one of the learning data of the machine learning model in the storage unit.

### CROSS-REFERENCE TO RELATED APPLICATION

This application claims priority to Japanese Patent Application No. 2023-139694 filed on Aug. 30, 2023, incorporated herein by reference in its entirety.

### BACKGROUND

### 1. Technical Field

The present disclosure relates to a machine learning model for use in image recognition.

### 2. Description of Related Art

There is disclosed a database construction system that automatically adjusts and collects supervised learning data for machine learning for executing recognition of an object from an output of a sensor that uses a detection result of a certain sensor as teacher data, and that constructs a database of the supervised learning data (e.g. Japanese Unexamined Patent Application Publication No. 2017-102838 (JP 2017-102838 A)).

### SUMMARY

An object of the present disclosure is to provide an information processing device and a method capable of efficiently collecting images for learning of a machine learning model for use in image recognition.

An aspect of the present disclosure provides an information processing device including a control unit configured to: receive a local image feature amount of one or more first objects included in a first image from a server; acquire a result of detection of objects by a first sensor that detects objects by emitting a predetermined signal for a range including a capturing range of a camera; acquire a local image feature amount of one or more objects included in a captured image for each of a plurality of images captured by the camera based on the result of detection of objects by the first sensor; and transmit a second captured image to the server as one of learning data for a machine learning model for use in image recognition, the second captured image being one of the captured images in which the local image feature amount of the one or more objects included in the captured image is similar to the local image feature amount of the one or more first objects.

Another aspect of the present disclosure provides an information processing device including a control unit configured to: transmit a local image feature amount of one or more first objects included in a first image to a first terminal; receive a second captured image captured by a camera from the first terminal, a local image feature amount of one or more objects included in the image being similar to a local image feature amount of the one or more first objects; and store the second captured image in a storage unit as one of learning data for a machine learning model for use in image recognition, in which the local image feature amount of one or more objects included in the image is acquired based on a result of detection of objects by a first sensor that detects objects by emitting a predetermined signal for a range including a capturing range of the camera.

Another aspect of the present disclosure provides a method including: causing a terminal to receive a local image feature amount of one or more first objects included in a first image from a server, acquire a result of detection of objects by a first sensor that detects objects by emitting a predetermined signal for a range including a capturing range of a camera, acquire a local image feature amount of one or more objects included in a captured image for each of a plurality of images captured by the camera based on the result of detection of objects by the first sensor, and transmit a second captured image to the server as one of learning data for a machine learning model for use in image recognition, the second captured image being one of the captured images in which the local image feature amount of the one or more objects included in the captured image is similar to the local image feature amount of the one or more first objects; and causing the server to transmit a local image feature amount of the one or more first objects to the terminal, receive the second captured image from the terminal, and store the second captured image in a storage unit as one of the learning data for a machine learning model.

According to the present disclosure, it is possible to efficiently collect images for learning of a machine learning model for use in image recognition.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an example of a system configuration of a learning data collection system of a machine learning model according to a first embodiment, and an example of a hardware configuration of a center server and a vehicle;

FIG. 2 is a diagram illustrating an example of a flow of a collection process of learning data according to the first embodiment;

FIG. 3 is a diagram illustrating an example of a functional configuration of a center server and a vehicle;

FIG. 4 is a diagram illustrating an example of information included in a collection plan;

FIG. 5 is an exemplary flow chart of a process for collecting relearning data of a center server; and

FIG. 6 is an example of a flowchart of a process of collecting relearning data of a vehicle.

### DETAILED DESCRIPTION OF EMBODIMENTS

The machine learning model can improve the accuracy of estimation by performing learning. For example, when the machine learning model performs image recognition for determining the type of the object captured from the captured image and the position in the captured image, the recognition result is evaluated based on whether the type and the position of the object are correct or not. In order to learn again for improving the estimation accuracy of a machine learning model used for image recognition, it is required to select an image similar to an image having a bad recognition result, and to create teacher data corresponding to the selected image.

Sorting of images for re-learning is often performed by a person. However, for example, when a relearning image is selected from a video of an in-vehicle camera, a moving image having a predetermined time length has to be viewed, resulting in a high human cost. In addition, since there is a variation in the criterion for determining an image similar to an image having a bad recognition result by a person, it is difficult to ensure the consistency of the selection criterion for the re-learning image. That is, the acquisition of the learning image of the machine learning model that performs the image recognition processing may be inefficient.

In view of the above problem, one aspect of the present disclosure causes a terminal to notify a local image feature amount of one or a plurality of first objects included in an image to be learned by a machine learning model, and transmit, to a server, a captured image of a camera in which the local image feature amount of the object included in the image is similar to the local image feature amount of the first object. As a result, an image similar to an image to be learned and useful for improving the accuracy of the machine learning model can be efficiently collected.

More specifically, one embodiment of the present disclosure is an information processing device including a control unit. The control unit receives, from the server, a local image feature amount of one or more first objects included in the first image. The control unit acquires a detection result of an object by a first sensor that emits a predetermined signal for a range including an imaging range of the camera and detects the object. The control unit acquires a local image feature amount of one or a plurality of objects included in the captured image for each of the plurality of captured images of the camera based on the detection result of the object by the first sensor. The control unit transmits, to the server, a second captured image in which the local image feature amount of one or a plurality of objects included in the captured image is similar to the local image feature amount of one or a plurality of first objects, among the plurality of captured images, as one of the learning data of the machine learning model used for image recognition.

The information processing device according to one embodiment is, for example, a computer connected to an in-vehicle camera such as an ECU or a data communication apparatus (DCM) mounted on a vehicle, or a computer connected to a monitoring camera or the like. The vehicle is, for example, an automobile, a motorcycle, a bicycle, or a railway vehicle. In addition to the vehicle, the information processing device according to one embodiment may be, for example, a computer connected to a camera mounted on an aircraft, a ship, or the like. The information processing device according to one embodiment may be, for example, a computer such as a smartphone and a tablet terminal. The control unit may be, for example, a processor such as Central Processing Unit (CPU) and Graphics Processing Unit (GPU), and circuitry such as Field Programmable Gate Array (FPGA).

The camera may be provided in the information processing device, or may be a device different from the information processing device and connected to the information processing device. Alternatively, the camera may be a camera provided in the information processing device or not connected thereto. The first sensor is, for example, a millimeter-wave radar, sonar, or Light Detection and Ranging (LiDAR). The predetermined signal used by the first sensor is a signal by radio waves or sound waves.

The machine learning model is, for example, a model of Convolutional Neural Network (CNN). However, in one aspect of the present disclosure, the machine learning model is not limited to that according to a particular algorithm.

The local image feature amount is a feature amount in a range corresponding to one object in the image. The local image feature amount is, for example, a value related to a color or a shape of an object. More specifically, local picture features include AKAZE, Scaled Invariance Feature Transform (SIFT), Histograms of Oriented Gradients (HOG), Speeded-Up Robust Features (SURF), and Local Binary Pattern (LBP). However, the local image feature amount is not limited thereto. The local image feature amount is not limited to one type of feature amount, and a plurality of types of feature amounts may be used.

According to one aspect of the present disclosure, a second captured image similar to the first image among the plurality of captured images of the camera is transmitted by the information processing device to the server as one of the data for learning of the machine learning model. For example, when the first image is an image with low estimation accuracy by the machine learning model, the server can collect, from the information processing device, a captured image similar to the first image that is useful for improving the estimation accuracy of the machine learning model. As a result, it is possible to efficiently collect data for learning of the machine learning model. Further, by using the detection result of the object by the first sensor, the position of the object in the captured image of the camera can be easily identified, and the processing load can be reduced.

Another aspect of the present disclosure is an information processing device including a control unit configured to execute: transmitting a local image feature amount of one or a plurality of first objects included in a first image to a first terminal; receiving, from the first terminal, a second captured image of a camera in which the local image feature amount of one or a plurality of objects included in the image is similar to the local image feature amount of one or a plurality of first objects; and storing the second captured image in a storage unit as one of learning data of a machine learning model used for image recognition. The information processing device is, for example, a server. The servers are, for example, dedicated computers and computers such as PC. The first terminal may acquire a local image feature amount of one or a plurality of objects included in the image based on a detection result of the object by the first sensor.

As another aspect, the present disclosure can specify a process executed by each of the information processing devices as a method executed by a computer. As another aspect, the present disclosure can also be specified as a program for causing a computer to execute the above-described method and a non-transitory computer-readable recording medium on which the program is recorded.

Hereinafter, embodiments of the present disclosure will be described with reference to the drawings. The configuration of the following embodiment is an example, and the present disclosure is not limited to the configuration of the embodiment.

### First Embodiment

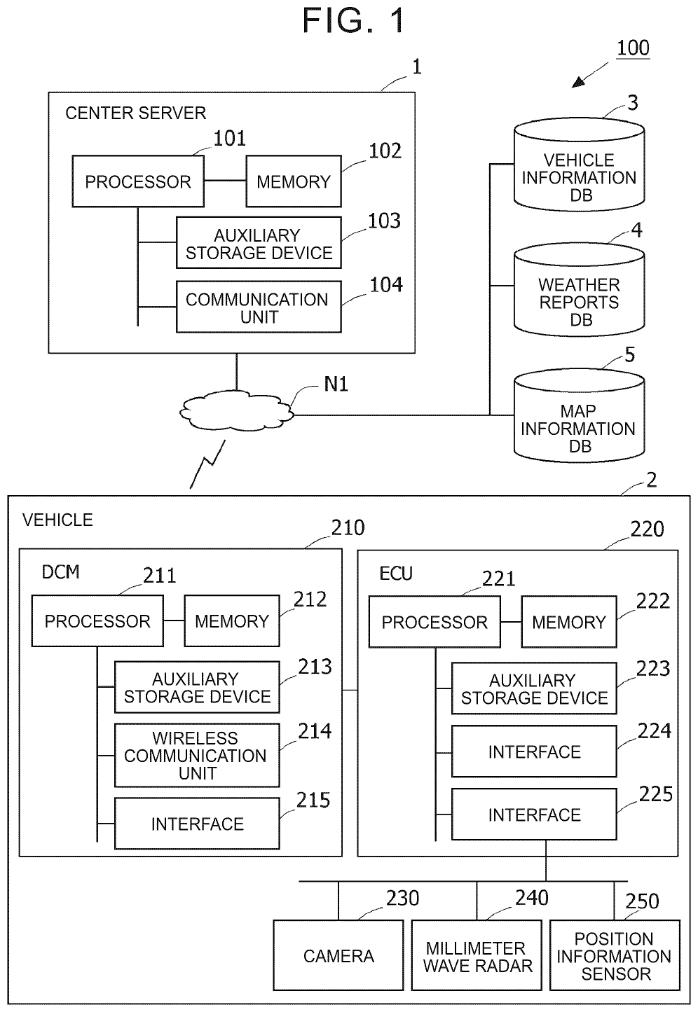

FIG. 1 is a diagram illustrating an example of a system configuration of a learning data collection system 100 for a machine learning model according to a first embodiment, and an example of a hardware configuration of a center server 1 and a vehicle 2. The learning data collection system 100 is a system that collects images used as learning data of a machine learning model that performs image recognition. The learning data collection system 100 includes a center server 1 and a vehicle 2. Although the learning data collection system 100 includes a plurality of vehicles 2, one vehicle 2 is extracted and shown in FIG. 1 for convenience.

The center server 1 and the vehicles 2 are connected to a network N1 and can communicate with each other through a network N1. The network N1 is, for example, a public network such as the Internet. The network N1 is also connected with a vehicle information DB 3, weather information DB 4, and a map information DB 5.

The vehicle 2 is a vehicle having a communication function called a so-called connected car. Information regarding the travel of the vehicle 2 is periodically collected and held in the vehicle information DB 3. The vehicle information held in the vehicle information DB 3 includes, for example, position information of the vehicle 2, a time stamp, sensor information such as a velocity, and the like.

In the first embodiment, for example, a machine learning model used to recognize images for safe driving of vehicles such as an advanced driving assistance system (ADAS) is assumed. Therefore, the center server 1 collects the captured image of the in-vehicle camera of the vehicle 2 as the learning data of the machine learning model used for image recognition. In the first embodiment, the center server 1 sets a similar image of an image having a lower accuracy (accuracy) of the estimation result by the machine learning model among the captured images of the in-vehicle camera of the vehicle 2 as a target to be collected as the re-learning data of the machine learning model. The center server 1 notifies the vehicle 2 of the local image feature amount of one or a plurality of objects included in the image having the low accuracy of the estimation result by the machine learning model. The vehicle 2 identifies, from the plurality of captured images of the in-vehicle camera, a captured image in which the local image feature amount of one or a plurality of objects included in the image is similar to the local image feature amount of one or a plurality of objects notified from the center server 1, and transmits the captured image to the center server 1.

As a result, the center server 1 can collect, from the vehicle 2, similar images of images that are appropriate as the data for the relearning of the machine learning model and that have lower accuracy (accuracy) of the estimation result by the machine learning model. Since an appropriate image is received from the vehicle 2 as the relearning data of the machine learning model at a pinpoint, for example, it is possible to suppress the human cost of manually selecting an appropriate image as the relearning data from the moving image data of a predetermined time length. Therefore, the learning data collection system 100 can improve the efficiency of collection of the re-learning data.

Next, the hardware configuration of each device will be described. The center server 1 can be configured using a dedicated information processing device (computer) such as a server machine. The center server 1 may be a collection (cloud) of one or more computers. The center server 1 is an example of an “information processing device”.

The center server 1 includes a processor 101, a memory 102, an auxiliary storage device 103, and a communication unit 104 as a hardware configuration. The memory 102 and the auxiliary storage device 103 are computer-readable recording media.

The auxiliary storage device 103 stores various programs and data used by the processor 101 when executing the programs. The auxiliary storage device 103 is, for example, an Erasable Programmable Read-Only Memory (EPROM), a hard disk drive, or a Solid State Drive (SSD). The programs stored in the auxiliary storage device 103 include, for example, an operating system (OS), an application program, and a training data-collection program. The learning data collection program is a program that collects captured images of an in-vehicle camera suitable for learning data of a machine learning model from the vehicle 2.

The memory 102 is a storage device that provides a storage area and a work area for loading programs stored in the auxiliary storage device 103 to the processor 101, and is used as a buffer. The memory 102 includes, for example, a solid-state memory such as Read Only Memory (ROM), Random Access Memory (RAM).

The processor 101 loads the program held in the auxiliary storage device 103 into the memory 102 and executes the program, thereby executing various kinds of processing. The processor 101 is, for example, a CPU, GPU or a Digital Signal Processor(DSP). The number of processors 101 is not limited to one, and a plurality of processors may be provided. The processor 101 is an example of a “control unit”.

The communication unit 104 is, for example, a Network Interface Card (NIC), an optical line interface, or the like. The communication unit 104 may be, for example, a wireless communication circuit connected to a wireless network such as a mobile wireless communication network such as a wireless LAN and a 5G, Long Term Evolution (LTE) or a 6G. The hardware configuration of the center server 1 is not limited to that shown in FIG. 1. The center server 1 may be a device including electric circuitry such as a dedicated Field-Programmable Gate Array (FPGA) or Application Specific Integrated Circuit (ASIC) for executing a corresponding process.

Next, the vehicle 2 includes a DCM 210, ECU 212, a camera 230, a millimeter-wave radar 240, and a position acquisition sensor 250. DCM 210 and ECU 220 are connected by, for example, an in-vehicle LAN. ECU 220, the camera 230, the millimeter-wave radar 240, and the position acquisition sensor 250 are connected by, for example, a Controller Area Network (CAN). However, the methods of connecting DCM 210, ECU 220, the camera 230, the millimeter-wave radar 240, and the position acquisition sensor 250 are not limited thereto. In FIG. 1, for the sake of convenience, hardware components related to the processing according to the first embodiment are extracted and shown, and the vehicle 2 further includes hardware components for controlling the traveling.

The position acquisition sensor 250 is, for example, a Global Positioning System (GPS) receiver. The detection value of the position acquisition sensor is position information of the current position of the vehicle 2. The position information is, for example, latitude and longitude. The position acquisition sensor 250 acquires position information at a predetermined cycle and outputs the position information to DCM 210 through ECU 220. The position information is transmitted from DCM 210 to the center server 1 as one vehicle information. The camera 230 may be a camera shared with a drive recorder or the like, for example.

The millimeter wave radar 240 performs object detection processing at a predetermined cycle. In the object detection process, the millimeter-wave radar 240 irradiates a radio wave in a frequency band in which the wavelength is in the millimeter unit, and measures the reflected wave to acquire position information such as the presence of an object existing in the irradiation direction and the distance and angle of the object. In the first embodiment, it is assumed that the imaging direction of the camera 230 and the irradiation direction of the millimeter wave radar 240 are oriented in the same direction, and the imaging range of the camera 230 is included in the irradiation range of the millimeter wave radar 240.

ECU 220 is, for example, an ECU or a multimedia ECU that processes ADAS. However. ECU 220 is not limited thereto. In the first embodiment, ECU 220 performs a process of identifying an image having a local image feature amount similar to the local image feature amount notified from the center server 1 from the captured image of the camera 230 using the detection result of the object by the millimeter-wave radar 240.

ECU 220 includes, as a hardware configuration, a processor 221, a memory 222, an auxiliary storage device 223, an interface 224 with an in-vehicle network, and an interface 225 with a CAN. The processor 221, the memory 222, and the auxiliary storage device 223 are the same as the processor 101, the memory 102, and the auxiliary storage device 103, respectively. The auxiliary storage device 223 stores application programs for clients of the learning data collection system 100. The application program for the client of the learning data collection system 100 is installed by the center server 1 through, for example, Over the Air (OTA). The client application program of the learning data collection system 100 is a program for specifying an image having a local image feature amount similar to the local image feature amount notified from the center server 1 from the captured image of the camera 230. ECU 220 is an exemplary “information processing device”. The processor 221 is an example of a “control unit”.

DCM 210 is responsible for the communication function of the vehicles 2. DCM 210 includes, as a hardware configuration, a processor 211, a memory 212, an auxiliary storage device 213, a wireless communication unit 214, and interfaces 215 with an in-vehicle network. The processor 211, the memory 212, and the auxiliary storage device 213 are the same as the processor 101, the memory 102, and the auxiliary storage device 103, respectively. The wireless communication unit 214 is, for example, a wireless communication circuit connected to a wireless network such as a mobile wireless communication network such as a wireless LAN and a 5G, LTE, 6G. Note that the hardware configurations of the center server 1 and the vehicle 2 illustrated in FIG. 1 are merely examples, and are not limited to the configuration illustrated in FIG. 1.

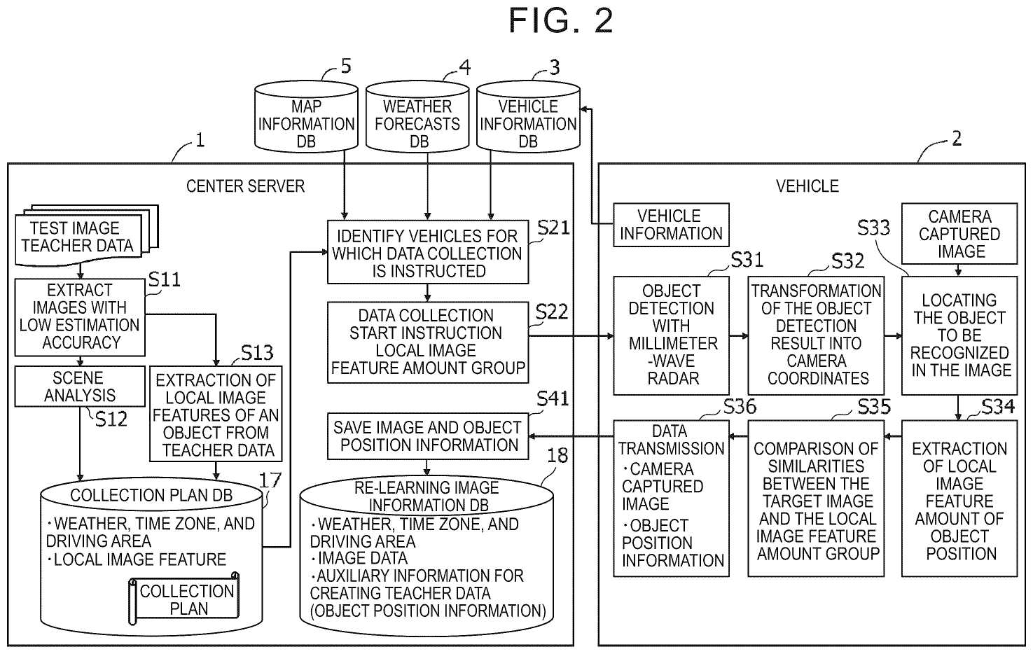

FIG. 2 is a diagram illustrating an example of a flow of a learning data collection process according to the first embodiment. First, the vehicle 2 periodically transmits vehicle information at a predetermined cycle, and the vehicle information is stored in the vehicle information DB 3.

In S11, the center server 1 extracts an image with lower estimation accuracy from the teacher data of the test image. The teacher data of the image is, for example, image data to which tagging of the type of the object and position information in the image are added for each object included in the image. A predetermined evaluation index is used to determine the estimation accuracy. The estimation accuracy of the machine learning model can be improved by causing the machine learning model to learn an image similar to an image with low estimation accuracy. Hereinafter, an image with poor estimation accuracy is referred to as a task image (question image). The image of the relearning data to be collected is an image similar to the target image. Hereinafter, the image of the relearning data to be collected may be referred to as a similar image of the target image. The task image is an example of a “first image”.

In S12, the center server 1 performs scene-analysis on the task images. The scene analysis is performed, for example, by a method of estimating from the shooting time and the position information of the shooting place, or by using a predetermined image scene recognition technique. The scene analysis may be performed, for example, by visual determination by a person. By the scene analysis, for example, information on the weather, the time zone, the traveling scene, and the like is acquired. The traveling scene is, for example, information related to a place where the vehicle 2 is traveling. The information regarding the traveling scene is, for example, information such as traveling on an expressway, traveling on a trunk road, traveling on a tunnel, or traveling on a mountain road. The information obtained from the scene-analysis is stored in the collection plan DB 17.

In S13, the center server 1 extracts the local image features of each of the one or more objects included in the task image from the task image corresponding to the teacher data extracted in S11. The local-image feature quantity is obtained by using an algorithmic feature quantity extractor such as AKAZE, SIFT, HOG, SURF and LBP. The set of local image features of the one or more objects extracted from the task image is stored in the collection plan DB 17.

The administrator of the learning data collection system 100 creates a collection plan for the re-learning data of the machine learning model. The collection plan includes information on when to start and end collection of the re-learning data, from which vehicle 2 to collect the re-learning data, how much to collect the re-learning data, and what image the re-learning data to collect. The collection plan is created by referring to the results of scene-analysis in S12 and using a group of local image features of the task image acquired in S13, for example.

In S21, the center server 1 refers to the vehicle information DB 3, the weather information DB 4, and the map information DB 5, and identifies the vehicle to which the collection of the relearning data is instructed according to the collection plan. As a result, the vehicle 2 under a situation similar to the scene analysis result of the task image can be specified as an instruction target, and it is possible to suppress an instruction to collect the data for re-learning to the vehicle 2 that is unlikely to capture the similar image of the task image. In S22, the center server 1 transmits, for example, a data collection start instruction and a local image feature amount of the task image to the vehicles 2 specified by S21 through OTA.

In S31, the vehicles 2 detect an object by the millimeter-wave radar 240. In the object detection of the millimeter wave radar 240, for example, the presence of an object is detected, but not up to the type of the object. In the object detection of the millimeter wave radar 240, the size and position of the detected object are also acquired. The millimeter wave radar 240 is an example of a “first sensor”.

In S32, the vehicle 2 converts the object detection result in S31 from the coordinates of the millimeter-wave radar 240 to the coordinates of the camera 230 using a predetermined coordinate transformation method. In S33, the vehicle 2 specifies, based on the coordinate transformation, the area where the object is located in the captured images as the position of the object to be recognized. The captured images used in S33 are captured at a time closest to a time at which the millimeter-wave radar 240 detects an object in S31.

In S34, the vehicle 2 extracts local image features for locations of objects identified in S33 in the captured image of the camera 230. Note that the type of the feature amount is the same as the local image feature amount of the target image. When a plurality of objects is detected by the millimeter wave radar 240, a position in the captured image is specified for each object, and a local image feature amount is extracted.

In S35, the vehicle 2 compares the similarity between the local image feature amount group of the target image and the local image feature amount of the captured image of the camera 230 among the captured images of the plurality of cameras 230. A method such as Bag-of-Visual Words (BoVW) is used to compare the similarity between the target image and the captured image of the camera 230.

In S36, the vehicle 2 transmits, to the center server 1, data of, for example, a captured image having a high-order predetermined number of degrees of similarity or a captured image having a degree of similarity equal to or greater than a predetermined threshold value, among the plurality of captured images. In addition to the captured image data, the position information of the object in the captured image obtained by the coordinate transformation in S32 is also transmitted. The position information of the object is, for example, information indicating a region in the captured image in which the object is present. For example, when a captured image is displayed, a frame line indicating an approximate shape of an object is displayed at the position of the object on the basis of the position information of the object, and the position where the object exists is easily visually recognized. The captured image transmitted from the vehicle 2 to the center server 1 is an example of a “second captured image”.

In S41, the center server 1 stores the captured image data received from the vehicles 2 in the re-learning image information DB 18 as one of the input data of the learning data. In addition, the center server 1 stores the position information of the object included in the captured image received from the vehicle 2 in the re-learning image information DB 18 as the assistance information for creating the teacher data.

Thereafter, the teacher data is created using the captured image data received from the vehicle 2 and the position information of the object included in the captured image. For example, the type of the object included in the captured image is determined by a person, labeled, and position information of each object is given, thereby creating teacher data. According to the position information of the object included in the captured image, for example, a frame line indicating a range in which the object exists on the captured image displayed on the display can be displayed. This makes it easier for the worker to identify an object to be labeled from the captured image, thereby improving work efficiency.

The estimation accuracy of the machine learning model can be improved by relearning the machine learning model using the image data and the teacher data as the input data of the relearning data collected in this manner. The machine learning model may be provided in the center server 1 or may be provided in a device different from the center server 1. Further, the learning of the machine learning model may be performed by the center server 1 or may be performed by a device different from the center server 1.

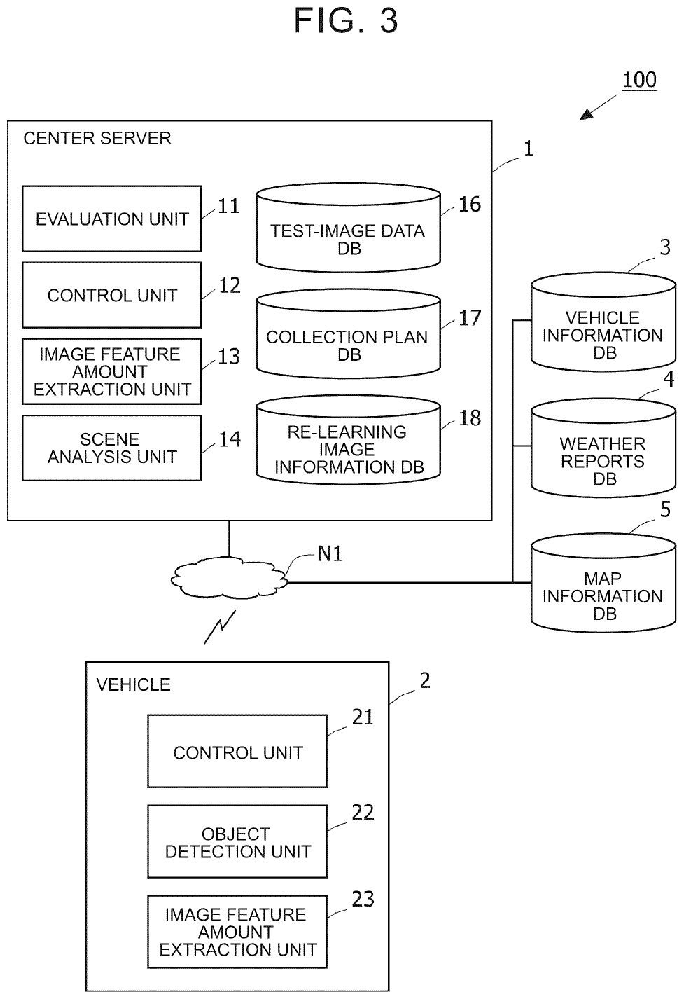

FIG. 3 is a diagram illustrating an example of a functional configuration of the center server 1 and the vehicle 2. The center server 1 includes, as functional components, an evaluation unit 11, a control unit 12, an image feature amount extraction unit 13, a scene analysis unit 14, a test image information DB 16, a collection plan DB 17, and a re-learning image information DB 18. These may be, for example, functions achieved by the processor 101 of the center server 1 executing a predetermined program. Each or a part of the functional components may correspond to a different program or a different hardware component (FPGA or the like).

The evaluation unit 11 evaluates the estimation result of the machine learning model of each image of the learned learning data according to a predetermined evaluation criterion, and extracts a problem image. The control unit 12 controls, for example, a process of acquiring the re-learning data corresponding to the process of S21, S22 and S41 in FIG. 2. Details of the processing of the control unit 12 will be described later. The image feature amount extraction unit 13 extracts a local image feature from the image. The scene analysis unit 14 performs scene analysis of an image by a predetermined method.

The test image information DB 16, the collection plan DB 17, and the re-learning image information DB 18 are created in, for example, a storage area of the auxiliary storage device 103 of the center server 1. The test image information DB 16 is learning data including a test image as input data and teacher data of the test image, and holds information on learning data in which the machine learning model has been learned. The collection plan DB 17 holds a collection plan and a scene-analysis result of the task image and a local image feature amount group. Details of the information included in the collection plan will be described later. The re-learning image information DB 18 stores a similar image of a task image collected from the vehicle 2 as input data, assistance information for creating teacher data, and teacher data.

Next, the vehicle 2 includes, as a functional configuration, a control unit 21, an object detection unit 22, and an image feature amount extraction unit 23. These may be functions achieved by, for example, the processor 221 of ECU 220 executing a predetermined program. Each or a part of the functional components may correspond to a different program or a different hardware component (FPGA or the like).

The control unit 21 controls, for example, a process of identifying a similar image of the task image from the captured image of the camera 230 corresponding to the process of S36 from S31 of FIG. 2 and transmitting the similar image to the center server 1. Details of the processing of the control unit 21 will be described later. The object detection unit 22 controls object detection by the millimeter wave radar 240. The image feature amount extraction unit 23 extracts a local image feature from the image. The local image feature amount acquired by the image feature amount extraction unit 23 is a local image feature amount of the same type as the local image feature amount acquired by the image feature amount extraction unit 13 of the center server 1.

The vehicle information DB 3 holds vehicle information periodically collected from the vehicle 2 at a predetermined cycle. The vehicle information includes, for example, position information of the vehicle 2 and information such as speed. The weather information DB 4 holds information about the weather. The information on the weather stores information on the weather, the sunshine, the precipitation, the wind speed, and the occurrence of lightning for each area. The map information DB 5 stores map information. The vehicle information DB 3, the weather information DB 4, and the map information DB 5 may be databases managed by the learning data collection system 100 or databases managed by external organizations. The functional configurations of the center server 1 and the vehicle 2 are not limited to the example illustrated in FIG. 3.

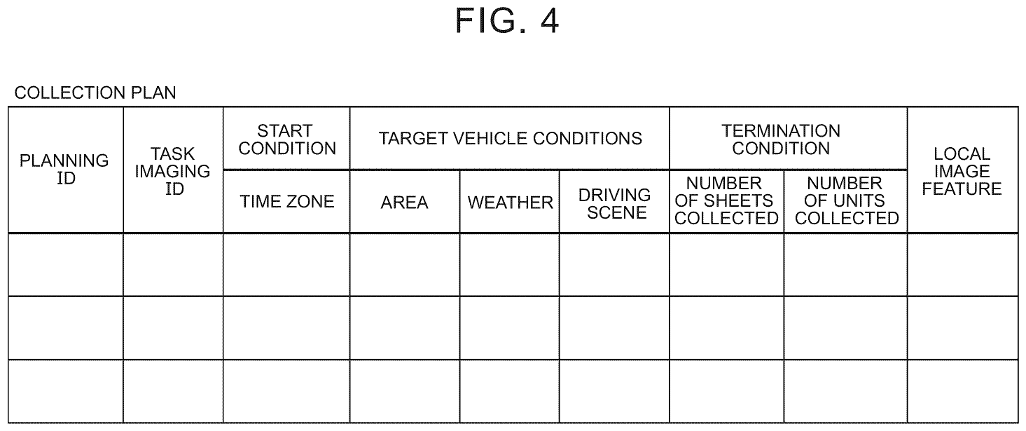

FIG. 4 is a diagram illustrating an example of information included in a collection plan; The collection plan includes fields of plan ID, task image ID, initiation conditions, target vehicle conditions, termination conditions, and local image features. In the field of the plan ID, the identification information of the collection plan is stored. The task image ID stores identification information of the task image.

In the field of the start condition, information defining the start condition of the re-learning data collection process for the target image is stored. The start condition field includes a time zone field. In the field of the time zone, information indicating a time zone in which the re-learning data collection process for the target image is executed is stored. The information indicating the time period may be determined based on, for example, a capturing time period of the task image obtained by scene analysis of the task image. The information indicating the time period may be, for example, a time period arbitrarily designated by the administrator of the learning data collection system 100. The start condition field may be empty, and when empty, the process of collecting the data for re-learning for the target image is started by the input of the start instruction from the administrator of the learning data collection system 100.

In the field of the target vehicle condition, information defining the condition of the vehicle 2 that is an instruction target for collection of the data for relearning corresponding to the task image is stored. The field of the target vehicle condition includes fields of an area, weather, and a traveling scene. In the field of the area, information indicating a geographical range for collecting the data for re-learning corresponding to the target image is stored. In the field of the weather, information indicating the weather to be the target of the collection of the data for the relearning corresponding to the target image is stored. In the field of the traveling scene, information indicating a traveling scene that is a target of collection of the data for re-learning corresponding to the target image is stored. The area, the weather, and the information stored in the field of the traveling scene may be determined based on, for example, a scene analysis result of the task image. Further, the information stored in the fields of the area, the weather, and the driving scene may be arbitrarily designated by the administrator of the learning data collection system 100, for example. Note that the fields of the area, the weather, and the driving scene may be empty. When the target vehicle condition is not set, for example, the vehicle 2 that is an instruction target for collection of the relearning data corresponding to the task image may be randomly specified.

In the field of the end condition, information defining the end condition of the re-learning data collection process for the target image is stored. The field of the end condition includes fields of the number of collected sheets and the number of collected sheets. In the field of the number of collected images, a lower limit value of the number of images to be collected as the data for re-learning of the target image is stored. When the number of captured images collected from the vehicle 2 reaches the value of the field of the number of collected images, the end of the re-learning data collection process for the target image is determined. In the field of the number of collected vehicles, the number of vehicles 2 to be collected as the data for re-learning of the subject image is stored. When the captured image is collected from the number of vehicles 2 having the value of the field of the number of collected images, the end of the collection process of the data for the relearning for the target image is determined. The end condition may be defined by either the number of collected sheets or the number of collected sheets, or may be defined by both of them. When the end condition is defined by both the number of collected sheets and the number of collected sheets, if both are satisfied, the end of the re-learning data collection process for the target image is determined. Note that the field of the end condition may be empty, and in this case, for example, a predetermined number of collected sheets may be used as the end condition.

In the field of the local image feature amount, a local image feature amount group extracted from the task image is stored. The local image feature amount group stored in the field of the local image feature amount is notified to the vehicle 2.

Note that the collection plan illustrated in FIG. 4 is an example, and each condition included in the collection plan can be flexibly set depending on what kind of image the learning data collection system 100 wants to collect as the learning data. For example, the number of captured images collected from one vehicle 2 may be defined as the end condition.

Further, from the captured data collected from the vehicle 2, for example, the relearning data may be acquired by further narrowing down using the vehicle information. The vehicle information also includes, for example, information such as the amount of depression of the brake pedal, the amount of lower ring of the handle, and the like, and can detect that the sudden braking or the sudden steering has been performed. For example, in a case where it is desired to collect a sudden braking and an image at a sudden steering wheel as learning data, the vehicle information may be attached to the captured image from the vehicle 2, and the captured image accompanied by the vehicle information indicating the sudden braking or the sudden steering wheel among the captured images collected from the vehicle 2 may be acquired as the re-learning data. Alternatively, an instruction to transmit an image in the case of a sudden brake and a sudden handle may be transmitted together with a data collection start instruction, and a similar image of a task image in the case of a sudden brake and a sudden handle may be transmitted from the vehicle 2.

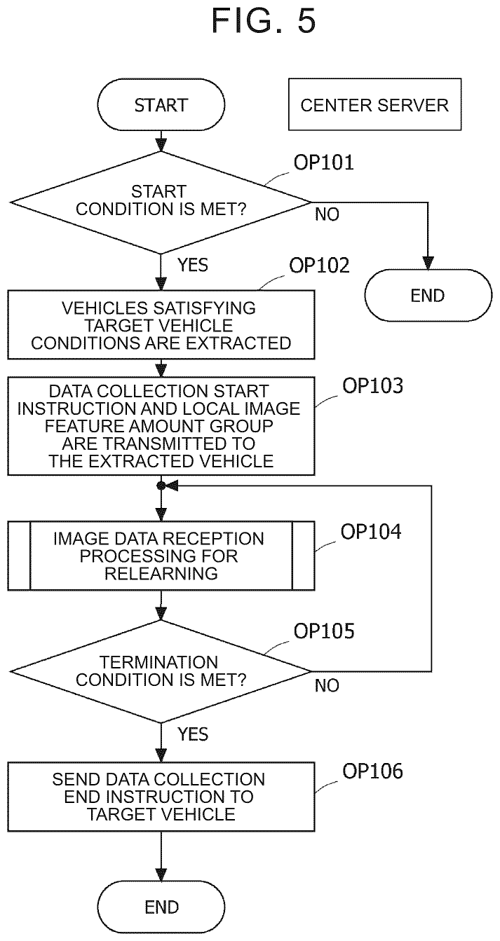

FIG. 5 is an example of a flowchart of a process of collecting the relearning data of the center server 1. The process illustrated in FIG. 5 is executed for each collection plan stored in the collection plan DB 17. The processing illustrated in FIG. 5 is repeatedly executed at a predetermined cycle. The execution subject of the processing illustrated in FIG. 5 is, for example, the processor 101 of the center server 1, but for convenience, the functional components will be mainly described.

In OP101, the control unit 12 determines whether the start-condition included in the collection plan is satisfied. When the start-condition is satisfied (OP101: YES), the process proceeds to OP102. When the starting condition is not satisfied (OP101: NO), the process illustrated in FIG. 5 ends.

In OP102, the control unit 12 extracts the plurality of vehicles 2 that satisfy the target vehicle conditions included in the collection plan. In OP103, the control unit 12 transmits a data-collection-start instruction and a local image-feature-amount group of the task image to the vehicles 2 extracted in OP102. In OP104, the control unit 12 performs a reception process of receiving the image data as the relearning data from the vehicles 2 and storing the image data in the re-learning image information DB 18.

In OP105, the control unit 12 determines whether or not an end-condition included in the collection plan is satisfied. If the termination condition is satisfied (OP105: YES), the process proceeds to OP106. If the termination condition is not satisfied (OP105: NO), the process proceeds to OP104.

OP106 transmits a data-collection-end instruction to the target vehicle. Thereafter, the process illustrated in FIG. 5 is ended.

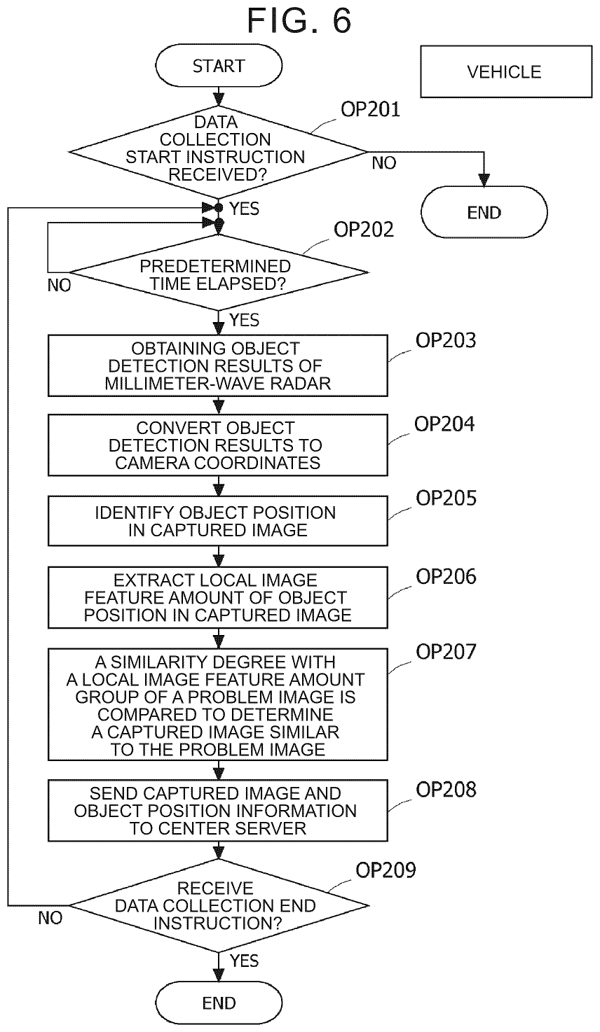

FIG. 6 is an example of a flowchart of a process of collecting the relearning data of the vehicle 2. The processing illustrated in FIG. 6 is repeatedly executed at a predetermined cycle. The executing entity of the process illustrated in FIG. 6 is, for example, the processor 221 of ECU 220, but for the sake of convenience, the functional components will be mainly described.

In OP201, the control unit 21 determines whether or not a data collection starting instruction has been received from the center server 1. When a data collection starting instruction is received from the center server 1 (OP201: YES), the process proceeds to OP202. Together with the data acquisition start instruction, a local image feature amount group of the task image is also received. When a data collection starting instruction has not been received from the center server 1 (OP201: NO), the process illustrated in FIG. 6 ends.

In OP202, the control unit 21 determines whether or not a predetermined period of time has elapsed. The predetermined time length is arbitrarily set in a range of, for example, one second to 10 seconds. When the predetermined period has elapsed (OP202: YES), the process proceeds to OP203. The control unit 21 enters a standby state until a predetermined time elapses.

In OP203, the control unit 21 acquires, from the object detection unit 22, a plurality of object detection results of the millimeter-wave radar 240 performed for the most recent predetermined time length. In OP204, the control unit 21 converts the object detection results of the millimeter-wave radar 240 acquired by OP203 into camera-coordinates. In OP205, the control unit 21 specifies the position of the object in the image on the basis of the object detection result corresponding to each of the plurality of captured images of the camera 230 for the latest predetermined time length.

In OP206, the control unit 21 makes a request to the image feature amount extraction unit 23 for each of the plurality of captured images of the camera 230 for the most recent predetermined time length, and acquires the local image feature amount extracted from the position of the object specified in OP205. In OP207, the control unit 21 compares the degree of similarity between the plurality of captured images of the camera 230 for the latest predetermined time length and the local image feature amount group of the target image, and determines a captured image similar to the target image. The captured image similar to the task image may be one or a plurality of captured images similar to the task image. In OP208, the control unit 21 transmits, to the center server 1, the captured image similar to the target image and the position information of the object in the captured image obtained by OP204.

In OP209, the control unit 21 determines whether or not a data collection termination instruction has been received from the center server 1. When a data collection end instruction is received from the center server 1 (OP209: YES), the process illustrated in FIG. 6 ends. If a data collection termination instruction has not been received from the center server 1 (OP209: NO), the process proceeds to OP202. When the process proceeds to OP202, the process from OP203 is performed after a predetermined period of time. Since the frequency of executing OP209 process from OP203 becomes a predetermined period of time, it is possible to suppress the impact on other processes of ECU 220 due to the burden caused by the re-learning data collection process.

Note that the process of acquiring the relearning data of the center server 1 illustrated in FIG. 5 and the process of acquiring the relearning data of the vehicle 2 illustrated in FIG. 6 are examples, and can be appropriately changed according to the embodiment.

### Operation and Effect of First Embodiment

In the first embodiment, the center server 1 can collect, from the vehicle 2, the captured image of the in-vehicle camera similar to the task image as the learning data of the machine learning model at a pinpoint. Accordingly, it is possible to collect an image suitable for learning of the machine learning model and having a consistent sorting criterion without using a human hand, and it is possible to improve the efficiency of the collection processing of the learning data of the machine learning model. Further, the estimation accuracy of the machine learning model can be further improved by learning using the learning data whose sorting criteria are consistent.

In the first embodiment, in the vehicle 2, the position of the object in the captured image of the corresponding camera 230 is specified using the object detection result by the millimeter wave radar 240. As a result, it becomes easy to identify the target region from which the local image feature amount in the captured image of the camera 230 is extracted, and it is possible to reduce the load of the collection processing of the data for re-learning in the vehicle 2 and shorten the time related to the processing. In addition, by transmitting the position information of the object in the captured image together with the captured image determined as the similar image of the target image, the position of the object in the captured image can be easily visually recognized by the person, and the efficiency of the human work related to the creation of the teacher data can be improved.

In addition, the re-learning data collection process according to the first embodiment can be executed by the vehicles 2 only by installing the client program of the learning data collection system 100 in OTA. Therefore, in the first embodiment, it is possible to achieve the collection of the relearning data without changing the hardware configuration of the vehicle 2.

Further, in the first embodiment, a collection plan is created based on the scene analysis result of the task image, and the center server 1 instructs, based on the collection plan, the vehicle under a situation similar to the situation in which the task image is captured at a timing in consideration of the situation in which the task image is captured, to start the collection of the relearning data. As a result, it is possible to improve the probability that the image collected from the vehicle 2 is more appropriate as the learning data. Further, even when the processing capability of the vehicle 2 is not high, it is possible to collect a captured image as more appropriate learning data.

### OTHER EMBODIMENTS

The above-described embodiments are merely examples, and the present disclosure can be appropriately modified without departing from the gist thereof.

In the first embodiment, the center server 1 collects captured images from the vehicle 2 as the learning data of the machine learning model, but the terminal that is the target of the collection of the learning data is not limited to the vehicle 2, and can be appropriately changed according to the purpose of use of the machine learning model. For example, the technique described in the first embodiment may be applied to a system that collects captured images of a camera mounted on a motorcycle, a bicycle, a railway vehicle, or the like as learning data. Further, the present disclosure is not limited to a vehicle moving on land, and may be applied to a system that collects captured images of a camera mounted on the vehicle from an aircraft, a ship, or the like as learning data. Alternatively, the present disclosure may be applied to a system that collects captured images of a surveillance camera, a fixed-point camera, or the like as learning data.

In the first embodiment, the vehicle 2 uses the object detection result of the millimeter wave radar 240 in order to specify the position of the object in the captured image, but instead of the millimeter wave radar 240, for example, a sensor used in another ADAS system such as a sonar or a LiDAR may be used.

In the first embodiment, ECU 220 performs the process of collecting the data for the relearning in the vehicle 2, but the hardware components for executing the process of collecting the data for the relearning in the vehicle 2 are not limited to ECU 220. For example, DCM 210, the drive recorder system, the car navigation system, and the like may execute a process of collecting the relearning data in the vehicle 2.

In the first embodiment, the center server 1 instructs the vehicle 2 to start and end the re-learning data collection process, but the present disclosure is not limited thereto. For example, the start condition and the end condition for each vehicle 2 may be transmitted together with the data collection start instruction, and the vehicle 2 may determine the start and end of the re-learning data collection process. The start condition may be defined by, for example, a time zone, an area, weather, a driving scene, and the like included in the collection plan. The termination condition may be defined by, for example, the number of collected similar images of the task image per vehicle 2.

The processes and means described in the present disclosure can be freely combined and implemented as long as there is no technical inconsistency.

Further, the processing described as being performed by one apparatus may be performed by a plurality of apparatuses in a shared manner. Alternatively, the processes described as being performed by different devices may be performed by a single device. In a computer system, it is possible to flexibly change which hardware configuration (server configuration) realizes each function.

The present disclosure can also be realized by supplying a computer program implementing the functions described in the above embodiments to a computer, and reading and executing the program by one or more processors included in the computer. Such a computer program may be provided to a computer by a non-transitory computer readable storage medium connectable to a system bus of the computer, or may be provided to the computer via a network. Non-transitory computer-readable storage media include, for example, any type of disk, such as a magnetic disk (floppy disk, hard disk drive (HDD), etc.), an optical disk (CD-ROM, DVD disk, Blu-ray disk, etc.), read only memory (ROM), random access memory (RAM), EPROM, EEPROM, magnetic card, flash memory, optical card, any type of medium suitable for storing electronic instructions.

What is claimed is:

1. An information processing device comprising a control unit configured to:
receive a local image feature amount of one or more first objects included in a first image from a server;
acquire a result of detection of objects by a first sensor that detects objects by emitting a predetermined signal for a range including a capturing range of a camera;
acquire a local image feature amount of one or more objects included in a captured image for each of a plurality of images captured by the camera based on the result of detection of objects by the first sensor; and
transmit a second captured image to the server as one of learning data for a machine learning model for use in image recognition, the second captured image being one of the captured images in which the local image feature amount of the one or more objects included in the captured image is similar to the local image feature amount of the one or more first objects.

2. The information processing device according to claim 1, wherein the control unit is further configured to:
for the captured images, specify one or more positions, in the captured image, of one or more objects included in the captured image based on the result of detection of objects by the first sensor, acquire a local image feature amount of the one or more objects included in the captured image from the specified one or more positions in the captured image, and make a comparison in similarity between the acquired local image feature amount of the one or more objects included in the captured image and the local image feature amount of the one or more first objects;
determine, based on a result of the comparison, one of the captured images in which the local image feature amount of the one or more objects included in the captured image and the local image feature amount of the one or more first objects are similar to each other as the second captured image; and
transmit position information, in the second captured image, on one or more objects included in the second captured image specified based on the result of detection of objects by the first sensor to the server, together with the second captured image.

3. An information processing device comprising a control unit configured to:
transmit a local image feature amount of one or more first objects included in a first image to a first terminal;
receive a second captured image captured by a camera from the first terminal, a local image feature amount of one or more objects included in the image being similar to a local image feature amount of the one or more first objects; and
store the second captured image in a storage unit as one of learning data for a machine learning model for use in image recognition, wherein
the local image feature amount of one or more objects included in the image is acquired based on a result of detection of objects by a first sensor that detects objects by emitting a predetermined signal for a range including a capturing range of the camera.

4. The information processing device according to claim 3, wherein the control unit is further configured to:
specify the first terminal from a plurality of terminals based on at least one of a location of each terminal, a weather, and a time zone; and
receive positions, in the second captured image, of one or more objects included in the second captured image specified based on the result of detection of objects by the first sensor from the first terminal, together with the second captured image, wherein
the learning data include teacher data corresponding to the second captured image prepared based on the positions, in the second captured image, of one or more objects included in the second captured image.

5. A method comprising:
causing a terminal to
receive a local image feature amount of one or more first objects included in a first image from a server,
acquire a result of detection of objects by a first sensor that detects objects by emitting a predetermined signal for a range including a capturing range of a camera,
acquire a local image feature amount of one or more objects included in a captured image for each of a plurality of images captured by the camera based on the result of detection of objects by the first sensor, and
transmit a second captured image to the server as one of learning data for a machine learning model for use in image recognition, the second captured image being one of the captured images in which the local image feature amount of the one or more objects included in the captured image is similar to the local image feature amount of the one or more first objects; and
causing the server to
transmit a local image feature amount of the one or more first objects to the terminal,
receive the second captured image from the terminal, and
store the second captured image in a storage unit as one of the learning data for a machine learning model.
